(19) United States
(12) Patent Application Publication
(10) Pub. No.: US 2010/0254142 A1
(43) Pub. Date: Oct. 7, 2010

(54) ILLUMINATION SYSTEM

(75) Inventor: CHIH-MING LAI, Chu-Nan (TW)

Correspondence Address: Altis Law Group, Inc.;ATTN: Steven Reiss, 288 SOUTH MAYO AVENUE, CITY OF INDUSTRY, CA, 91789, US

(73) Assignee: FOXSEMICON INTEGRATED TECHNOLOGY, INC., Chu-Nan (TW)

(21) Appl. No.: 12/713,176

(22) Filed: Feb. 26, 2010

(30) Foreign Application Priority Data
Apr. 3, 2009 (CN) 200910301334.1

(51) Int. Cl. G02B 27/20; F21V 3/00; F21V 5/00; F21V 17/02

(52) U.S. Cl. 362/259; 362/311.01; 362/311.09; 362/282

(57) ABSTRACT

An illumination system comprises a light source, an optical element, a detection module, and a drive module. The optical element has a plurality of light transmitting regions through which light from the light source passes to produce a corresponding distribution curve of luminous intensity. A detection module thereof is used to detect a subject area and output a detection signal, and the drive module moves the optical element according to the detection signal of the detection module to generate required light intensity pattern of the light emitted from the light source, in which the light passes through a corresponding one of the light transmitting regions of the optical element.

### BACKGROUND

1. Technical Field

The present disclosure relates to an illumination system, and particularly to an illumination system which can adjust a distribution curve of its luminous intensity.

2. Description of Related Art

Light emitting diodes' (LEDs) many advantages, such as high luminosity, low operational voltage, low power consumption, compatibility with integrated circuits, easy driving, long-term reliability, and environmental friendliness have promoted wide use as a light source.

Joseph Bielecki et al. in IEEE, 23rd IEEE SEMI-THERM Symposium, “Thermal Considerations for LED Components in an Automotive Lamp.” characterize light emitting diodes as one kind of semiconductor device changing current into light of specific wavelength.

A distribution curve of luminous intensity quantifies light emitted by a light source, which, for a traditional fixed light source, normally has radial or isotropic characteristics, such that the distribution curve of luminous intensity of an illumination apparatus using the light source generally is decided by optical elements of the apparatus, such as a cover or lens. FIG. 1 shows the distribution curve of luminous intensity of a LED light source representing Lambertian distribution. As shown, the Full Width at Half Maximum of the light source is within ±60°; accordingly the Full Width at Half Maximum is 120°.

Changing the distribution curve of luminous intensity of the light source requires alteration of the primary optical element of the LED or light source, an adjustment that cannot normally be made arbitrarily, nor can such alteration be made according to changes in the area of illumination.

What is needed therefore, is an illumination system which can ameliorate the described limitations.

### BRIEF DESCRIPTION OF THE DRAWINGS

Many aspects of the present illumination system can be better understood with reference to the following drawings. The components in the drawings are not necessarily drawn to scale, the emphasis instead being placed upon clearly illustrating the principles of the present illumination system. Moreover, in the drawings, like reference numerals designate corresponding parts throughout the several views.

FIG. 1 is a schematic view of a distribution curve of luminous intensity of a LED light source.

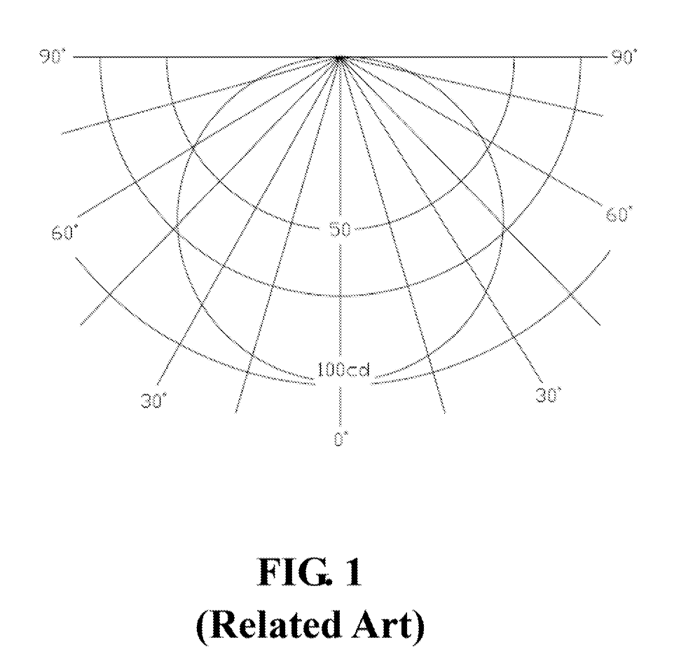

FIG. 2 is a schematic view of an illumination system in accordance with a first embodiment.

FIG. 3 is a schematic view of an illumination system in accordance with a second embodiment.

FIG. 4 is a schematic cross section of a micro-structure 224a of light emitting surface 223a in FIG. 3.

FIG. 5 is a schematic view of a distribution curve of luminous intensity of light from the light source passing through the micro-structure in FIG. 4.

FIG. 6 is a schematic cross section of a micro-structure 224b of light emitting surface 223b in FIG. 3.

FIG. 7 is a schematic view of a distribution curve of luminous intensity of light from the light source passing through the micro-structure in FIG. 6.

FIG. 8 is a schematic cross section of a micro-structure 224c of light emitting surface 223c in FIG. 3.

FIG. 9 is a schematic view of a distribution curve of luminous intensity of light from the light source passing through the micro-structure in FIG. 8.

FIG. 10 is a schematic cross section of a micro-structure 224d of light emitting surface 223d in FIG. 3.

FIG. 11 is a schematic view of a distribution curve of luminous intensity of light from the light source passing through the micro-structure in FIG. 10.

FIG. 12 is a schematic view of an illumination system in accordance with a third embodiment.

### DETAILED DESCRIPTION

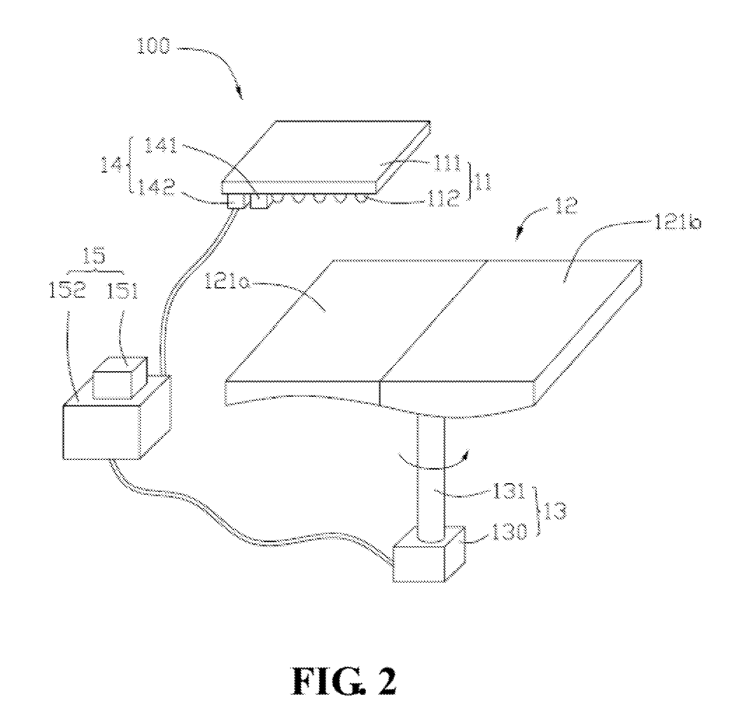

Referring to FIG. 2, a schematic view of an illumination system 100 in accordance with a first embodiment, the illumination system 100 includes a light source 11, an optical lens 12, a drive module 13, and a detection module 14.

The light source 11 includes a substrate 111 and a plurality of light emitters 112 located thereon, which together constitute a light emitting surface. The light emitters 112 can be laser, light emitting diodes, organic light emitting diodes, or light emitting diode modules.

The optical lens 12 is located on the light emitting surface of the light source 11. The optical lens 12 is planar and comprises a lens unit 121a, a plane concave lens scattering light from the light source 11, and lens unit 121b, a plane convex lens collecting light from the light source 11 in an area.

The optical lens 12 can be silicone, glass, polymethyl methacrylate (PMMA), polycarbonate (PC), epoxy, or polyethylene terephthalate.

The optical lens 12 can include a plurality of lens units not limited to two. The shape of the lens units can be convex, concave, spherical, or Fresnel, not being limited to plane convex or concave.

The drive module 13 includes a drive unit 130 and a rotational axle 131, wherein the drive unit 130 is connecting to the rotational axle 131, and the rotational axle 131 is connecting to the optical lens 12.

The detection module 14 is a laser detection module comprising a laser emitter 141 and a laser receptor 142. In this embodiment, the laser emitter 141 and laser receptor 142 are set up on the substrate 111 and at the light emitting surface of the light source 11. The detection module 14 can alternatively be set up elsewhere as long as it can detect the subject area.

The laser emitter 141 sends out a laser signal to detect the subject area. The laser receptor 142 receives a returned laser signal reflected from objects in the subject area. Preferably, the illumination system 100 further comprises a control module 15 including an information storage device 151 and an information processing device 152. The information storage device 151 stores work pattern information corresponding to the distribution curve of luminous intensity of light from the light source 11 passing through each lens unit. The information processing device 152 receives the detection signal output from the laser receptor 142, compares it with the work pattern signal stored in the information storage device 151 and locates corresponding work pattern information according to the detection signal and delivers to the drive module 13. The drive module 13 rotates the optical element 12 via rotational axle 131, relocating the lens unit to comply with the work pattern information and adjust the distribution curve of luminous intensity to provide desired illumination.

Since, with motion of objects in the subject area, illumination requirements will change accordingly, detection and corresponding adjustment of the lens unit are executed continuously. Thus, changes to the distribution curve of luminous intensity of the light source 11 respond to the subject area with greater flexibility.

Additional lens units included in the optical lens 12 broaden the types of distribution curve of luminous intensity that can be adjusted by the light source 11.

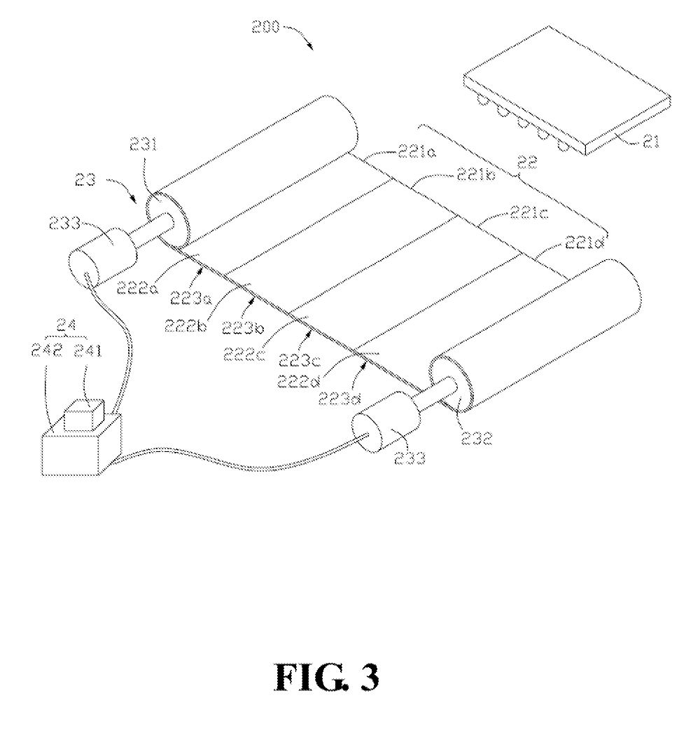

Referring to FIG. 3, a schematic view of an illumination system 200 in accordance with a second embodiment, the illumination system 200 includes a light source 21, an optical lens 22, a drive module 23, and a detection module 24. The structure of light source 21 is fundamentally the same as that provided in the first embodiment.

The optical film 22, located on the light emitting surface of the light source 21, is planar and flexible. The optical film 22 comprises four light transmitting regions 221a, 221b, 221c and 221d. The four light transmitting regions 221a, 221b, 221c and 221d separately comprise a light incident surface 222a, 222b, 222c, and 222d opposite to light source 21 and a light emitting surface 223a, 223b, 223c, and 223d opposite to light incident surface 222a, 222b, 222c, and 222d. A micro-structure is separately disposed on the four light emitting surface 223a, 223b, 223c, and 223d.

The optical film 22 can be silicone, glass, PMMA, PC, epoxy, or polyethylene terephthalate.

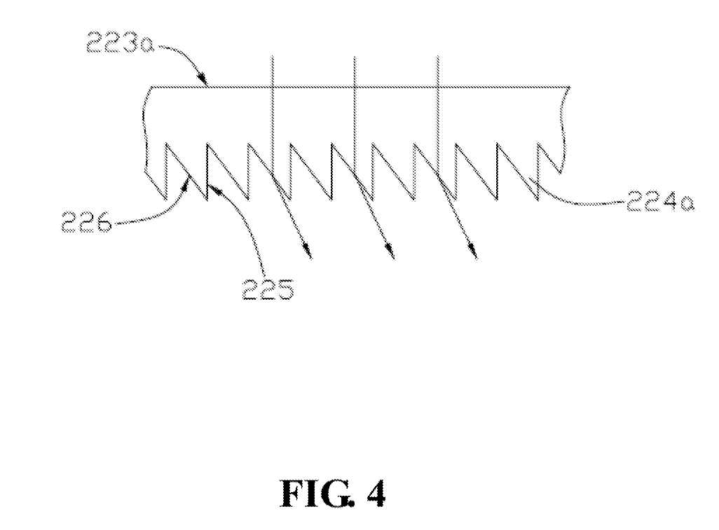

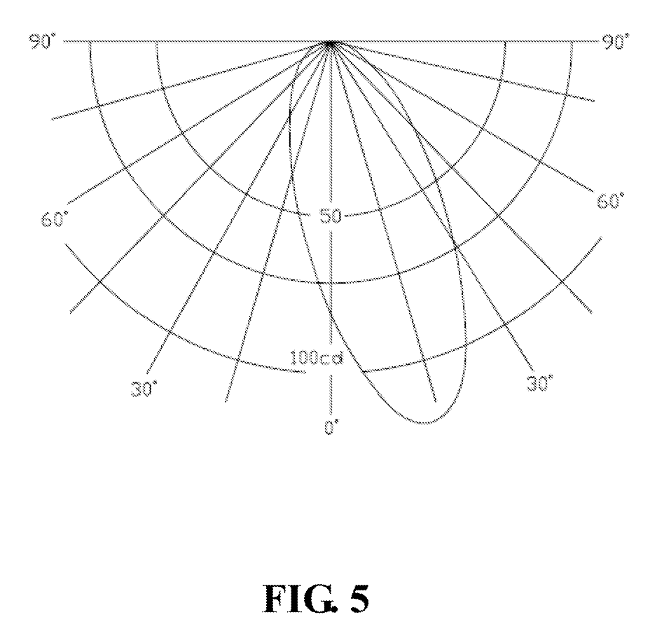

FIG. 4 is a schematic cross section of a micro-structure 224a of the light emitting surface 223a, including a plurality of sawtooth protrusions, each comprising a first surface 225 perpendicular to the light emitting surface 223a and a second surface 226 connecting to the first surface 225, wherein the second surface 226 and the first surface 225 form an acute angle. The light from the light source 21 is refracted by and then emitted from the second surface 226. FIG. 5 is a schematic view of a distribution curve of luminous intensity of light from the light source 21 passing through the micro-structure 224a. The light from the light source 21 passing through the micro-structure 224a shifts in a predetermined direction. The refractive light from the light source 21 passing through the micro-structure 224a shifts away from the second surface 226 when the angle between the first surface 225 and the second surface 226 increases.

Since the first surface 225 needs not be perpendicular to the light transmitting region 221a, light of various refractive directions can be generated by changing the angle between the first surface 225 and the second surface 226 of the micro-structure 224a.

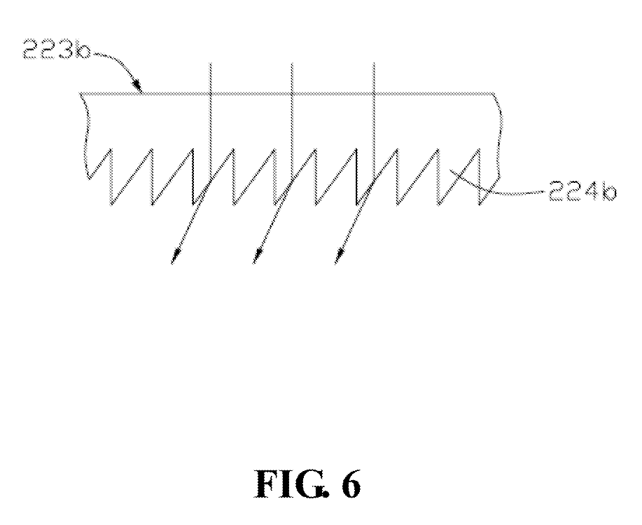

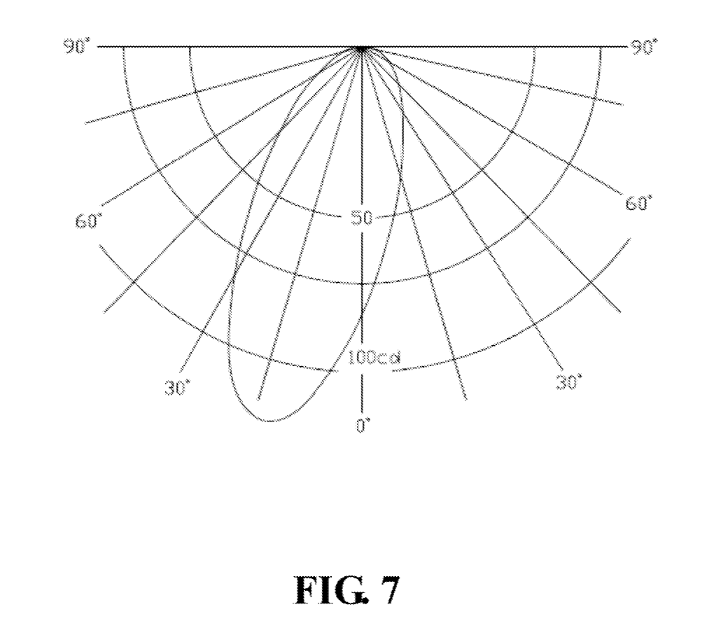

FIG. 6 is a schematic cross section of a micro-structure 224b of the light emitting surface 223b, including a plurality of sawtooth protrusions symmetrical with the sawtooth protrusions of the micro-structure 224a, such that light from the light source 21 refracts in a direction opposite to that of FIG. 4(a) after passing through the micro-structure 224b. Please refer to FIG. 7, it is a schematic view of a distribution curve of luminous intensity of light from the light source 21 passing through the micro-structure 224b. The light from the light source 21 refracts in a direction opposite to that of FIG. 5 after passing through the micro-structure 224b.

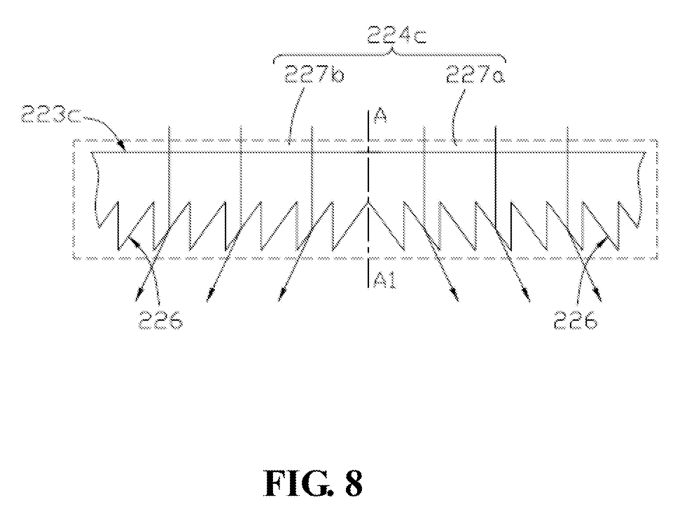

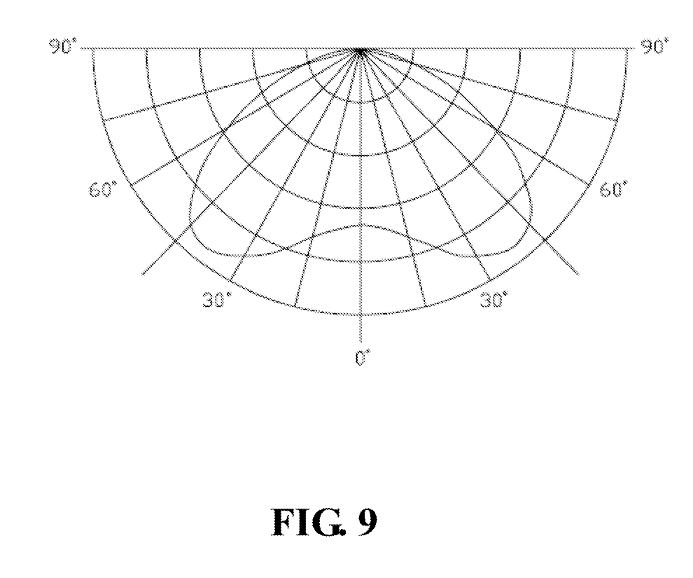

FIG. 8 is a schematic cross section of a micro-structure 224c of light emitting surface 223c. The micro-structure 224c includes a first micro-structure 227a and a second micro-structure 227b. The first micro-structure 227a has the same structure as the micro-structure 224a, with both symmetrical about axis A-A1. The second surface 226 of the sawtooth protrusions of the first micro-structure 227a adjacent to the axis A-A1 and the second surface 226 of the sawtooth protrusions of the second micro-structure 227b adjacent to the axis A-A1 are connected and convergent toward the light source 21, such that light from light source 21 scatters after passing through the micro-structure 224c. FIG. 9 is a schematic view of a distribution curve of luminous intensity of light from the light source 21 passing through the micro-structure 224c. The light from the light source 21 scatters after refracting through the micro-structure 224c.

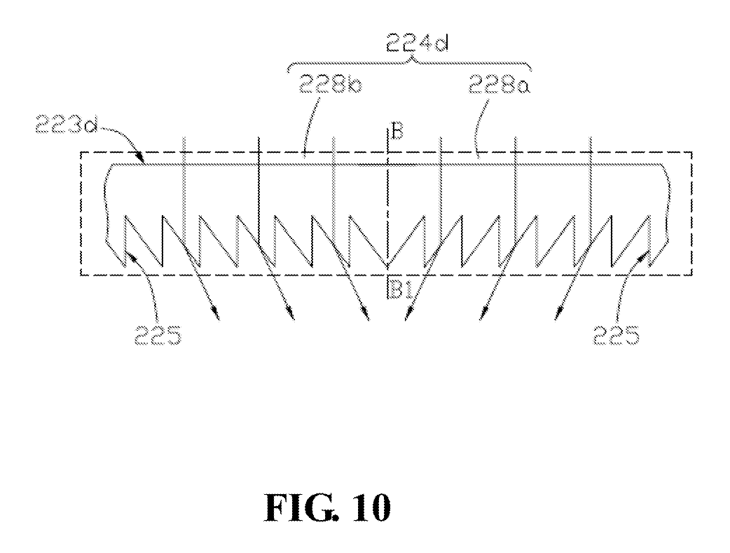

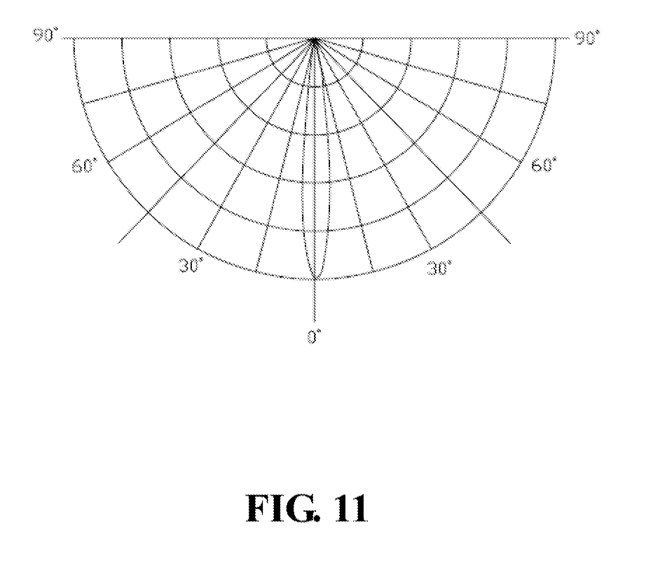

FIG. 10 is a schematic cross section of a micro-structure 224d of the light emitting surface 223d, including a first micro-structure 228a and a second micro-structure 228b. The first micro-structure 228a has the same structure as the micro-structure 222b, and both are symmetrical about axis B-B1. The second surface 226 of the sawtooth protrusions of the first micro-structure 228a adjacent to the symmetrical axis B-B1 and the second surface 226 of the sawtooth protrusions of the second micro-structure 228b adjacent to the symmetrical axis B-B1 are connected and convergent away from the light source, such that light from the light source 21 is collected and scatters along the symmetrical axis B-B1 of the first micro-structure 228a and the second micro-structure 228b after refracting through the micro-structure 222d. FIG. 11 is a schematic view of a distribution curve of luminous intensity of light from the light source 21 passing through the micro-structure 224d. Light from the light source 21 is collected and scatters along the symmetrical axis B-B1 of the first micro-structure 227 and the second micro-structure 228 after refracting through the micro-structure 224d.

The drive module 23 includes a first roller 231, a second roller 232, and a control unit 233. Two ends of the optical film 22 are connected separately to the first roller 231 and the second roller 232. The control unit 233 directs operation of the first roller 231 and the second roller 232.

The detection module 24 is an infrared detection module comprising an infrared emitter 241 and an infrared receptor 242. In this embodiment, the illumination system 200 targets elements in the subject area moving with a certain temperature, as detected by infrared signal emitted by infrared emitter 241 and returned to infrared receptor 242. The received signal is transferred to control unit 233 to direct the optical film 22 to move, such that light from the light source scatters from the light transmitting region and the corresponding distribution curve of luminous intensity of the heat source provides the desired illumination.

In this embodiment, the optical film 23 can include a plurality of light transmitting regions, with the shape not limited to that described, wherein other shapes or arrangements are equally applicable. Similarly, the protrusions of the micro-structures located on optical film 23 are not limited to a sawtooth configuration, and can be of other shapes such as curved, convex, cylindrical, concave, or other.

Additional light transmitting regions included in the optical lens 22 broaden the types of distribution curve of luminous intensity that can be adjusted by the light source 21.

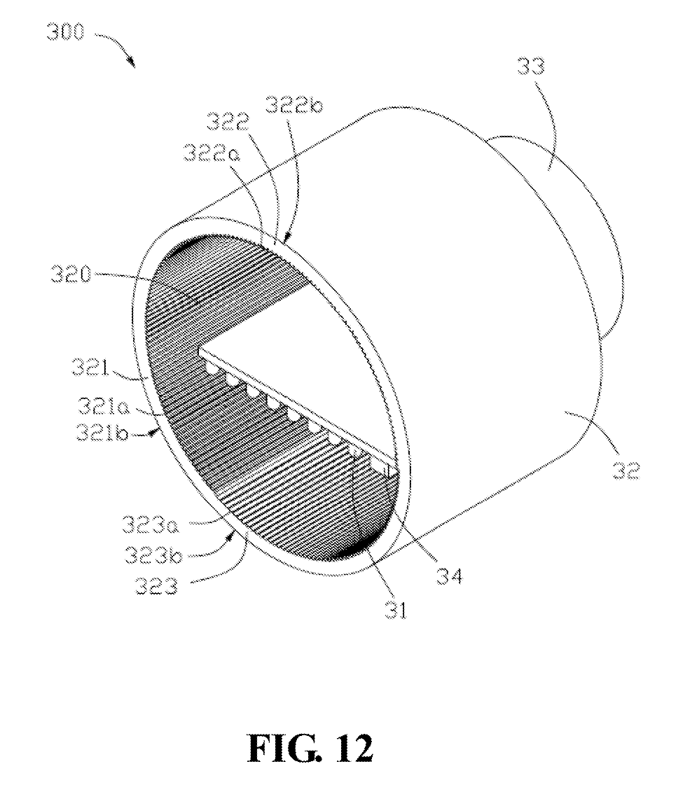

FIG. 12 is a schematic view of an illumination system 300 in accordance with a third embodiment, differing from that of the first embodiment only in that the optical lens 32 is tubular and includes a receiver 320 with the light source 31 received therein. The optical lens 32 includes three curved light transmitting regions 321, 322, and 323, each including separately a light incident surface 321a, 322a, and 323a opposite to light source 31 and a light emitting surface 321b, 322b, and 323b opposite to light incident surface 321a, 322a, and 323a. A micro-structure is separately disposed on the three light incident surfaces 321a, 322a, and 323a, wherein the light incident surface 321a includes a sawtooth protrusion, the light incident surface 322a is convex, and the light incident surface 323a is concave. Accordingly, light from the light source 31 passes separately through the three light transmitting regions to allow different distribution curves of luminous intensity to meet the needs of different subject areas.

The optical lens 32 can include a plurality of light transmitting regions including other micro-structures.

Drive module 33 is connected with the optical lens 32, and in this embodiment, is a motor.

The detection module 34 is disposed on the light emitting surface of the light source 31 and can be a laser detection module, infrared detection module, or other. The detection module 34 detects target elements in the subject area and transfers the returned detection signal to the drive module 33, which moves the optical lens 32, such that light from light source 31 scatters from the light transmitting region to acquire the corresponding distribution curve of luminous intensity for the subject area.

The structure of the illumination system is simple, providing adjustment of a distribution curve of luminous intensity of light from a light source as needed. Further, power is conserved, since only the needed illumination is generated.

It is to be understood, however, that even though numerous characteristics and advantages of the disclosure have been set forth in the foregoing description, together with details of the structures and functions of the embodiment(s), the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An illumination system, comprising a light source and an optical element, the optical element comprising a plurality of light transmitting regions through which light from the light source is passed to produce a corresponding distribution curve of luminous intensity, wherein the illumination system further includes a detection module and a drive module, the detection module determining the subject area and output the resulting detection signal, and the drive module moving the optical element according to the detection signal from the detection module such that light from the light source is emitted from one of the light transmitting regions of the optical element.

2. The illumination system of claim 1, wherein the optical element is an optical lens.

3. The illumination system of claim 2, wherein the optical lens thereof is convex, plane convex, concave, plane concave, spherical, or Fresnel.

4. The illumination system of claim 2, wherein the optical lens is planar.

5. The illumination system of claim 2, wherein the optical lens is tubular.

6. The illumination system of claim 2, wherein the drive module comprises a rotational axle connecting to the optical lens and a drive unit connecting to the rotational axle, and the drive unit rotates the rotational axle to move the optical lens.

7. The illumination system of claim 1, wherein the optical element is an optical film.

8. The illumination system of claim 7, the drive module including a first roller and a second roller, to which the two ends of the optical film are connected separately, wherein rolling of the rollers moves the optical film.

9. The illumination system of claim 1, each light transmitting region comprising a light incident surface opposite to the light source, and a light emitting surface opposite to the light incident surface, wherein at least one of the light incident surface and the light emitting surface of the optical region comprises a micro-structure.

10. The illumination system of claim 9, wherein the micro-structure thereof comprises sawtooth protrusions, curved protrusions, cylindrical protrusions, curved concavity, or cylindrical concavity.

11. The illumination system of claim 9, wherein the micro-structure is a sawtooth protrusion comprising a first surface perpendicular to the optical lens and a second surface connected to and forming an acute angle with the first surface.

12. The illumination system of claim 9, wherein the micro-structures comprise a first micro-structure and a second micro-structure, the first micro-structure is a sawtooth protrusion comprising a first surface perpendicular to the optical lens and a second surface connected to and forming an acute angle with the first surface, and the second micro-structure is mirror-symmetrical with the first micro-structure.

13. The illumination system of claim 12, wherein the second surface of the sawtooth protrusion of the first micro-structure adjacent to the second micro-structure connects to the second surface of the sawtooth protrusion of the second micro-structure adjacent to the first micro-structure, the two connected second surfaces converging toward the light source.

14. The illumination system of claim 12, wherein the second surface of the sawtooth protrusion of the first micro-structure adjacent to the second micro-structure connects to the second surface of the sawtooth protrusion of the second micro-structure adjacent to the first micro-structure, the two connected second surfaces converging away from the light source.

15. The illumination system of claim 1, wherein the detection module comprises an infrared emitter and an infrared receptor.

16. The illumination system of claim 1, wherein the detection module comprises a laser emitter and a laser receptor.

17. The illumination system of claim 1, further comprising an information storage device and an information processing device, wherein the information storage device is used to store the work pattern information corresponding to the distribution curve of luminous intensity made by the light from the light source passing through the light transmitting regions, the information processing device chooses the corresponding work pattern information according to the detection signal detected and output by the detection module to deliver the work pattern information needed to the drive module, and the drive module moves the optical element according to the work pattern information to the light transmitting region corresponding to the work pattern information.
